(19) United States
(12) Patent Application Publication
(10) Pub. No.: US 2015/0269142 A1
(43) Pub. Date: Sep. 24, 2015

(54) SYSTEM AND METHOD FOR AUTOMATICALLY GENERATING A DATASET FOR A SYSTEM THAT RECOGNIZES QUESTIONS POSED IN NATURAL LANGUAGE AND ANSWERS WITH PREDEFINED ANSWERS

(71) Applicant: Support Machines LTD., Hod Hasharon (IL)

(72) Inventors: Amit Antebi, Hod Hasharon (IL); Joel Rotem, Kfar Sirkin (IL)

(21) Appl. No.: 14/662,251

(22) Filed: Mar. 19, 2015

Related U.S. Application Data
(60) Provisional application No. 61/967,502, filed on Mar. 20, 2014.

(51) Int. Cl. G06F 17/28; G06F 17/30; G06Q 30/00

(52) U.S. Cl. CPC G06F 17/28; G06Q 30/01; G06F 17/3064; G06F 17/30663

(57) ABSTRACT

A non-transitory computer readable medium that stores instructions that once executed by a computerized system causes the computerized system to execute the steps of: analyzing transcripts of natural language interactions between a user and an information provider to recognize and define golden answers; locating occurrences of golden answers within the plurality of transcripts; collecting, from the plurality of transcripts, a plurality of questions leading to a golden answer; and converting a plurality of questions leading to a golden answer, to keywords, concepts and weights.

### RELATED APPLICATIONS

This application claims priority from U.S. provisional patent 61/967,502 filing date Mar. 20, 2014 which is incorporated herein by reference.

### FIELD OF THE INVENTION

The present invention generally relates to a system and method for automatically generating a dataset for a system that recognizes questions posed in natural language and answers with predefined answers. More particularly, the present invention pertains to a system and method for recognizing commonly used answers, such as those posed in customer service and the patterns of words used in questions to which these answers provide relevant response. The system or method may feed into an automated user interaction system such as customer service chat.

### BACKGROUND OF THE INVENTION

Automated customer support system are known in prior art such as the system detailed in U.S. Pat. No. 8,548,915 B2 or U.S. Pat. No. 7,603,413 B1. Typically, these systems use a pre-defined dataset which includes answers crafted in advance to provide the most effective solution to most commonly asked questions and problems. Often, these answers are also used by human customer support agents and are sometimes referred to as “golden answers”. In addition to these golden answers, automated answering system often contain a set of rules or guidelines designed to help match the optimal golden answer to a customer's query.

Often, these rules are based on matching a set of keywords to each answer. A query is analyzed to detect the presence of each keyword. A score is derived by multiplying each keyword by a weight (score) which is designed to indicate how indicative each keyword is of a given answer being relevant. A mathematical computation such as adding the weights of all present keywords is derived for each golden answer. By comparing the score to a predetermined threshold, the system can decide whether the golden answer is relevant. If more than one golden answer is found to be relevant, multiple answers can be displayed. Alternatively, the system may display one or more answers with the highest scores.

In some cases, creating the dataset for the automated response system requires extensive manual work to define golden answers and analyze the optimal configuration of keywords and weights for each golden answer. This invention describes a system or method to automate the entire process of creating the dataset, or to create an initial dataset which can then be manually optimized, saving considerable time and effort.

### SUMMARY

According to an embodiment of the invention there may be provided a non-transitory computer readable medium that may store instructions that once executed by a computerized system causes the computerized system to execute the steps of: analyzing transcripts of natural language interactions between a user and an information provider to recognize and define golden answers; locating occurrences of golden answers within the plurality of transcripts; collecting, from the plurality of transcripts, a plurality of questions leading to a golden answer; and converting a plurality of questions leading to a golden answer, to keywords, concepts and weights.

According to an embodiment of the invention there may be provided a system for automatically generating a dataset for a device that recognizes questions posed in a natural language and answers with predefined golden answers; wherein the system may include: a module for recognizing and defining golden answers that is configured to analyze transcripts of natural language interactions between a user and an information provider to recognize and define golden answers; a module for locating occurrences of golden answers within the plurality of transcripts; a module for collecting, from the plurality of transcripts, a plurality of questions leading to a golden answer; and a converting module for converting a plurality of questions leading to a golden answer to at least one keyword to at least one keyword weight; wherein multiple golden answers, multiple keywords associated with the multiple golden answers and multiple keyword weights form a dataset; wherein an incoming question is evaluated as being a question that is responded by a golden answer using the dataset.

At least one golden answer is associated with a concept that comprises a group of keywords of similar meaning and the converting module may assign a concept weight; wherein the concept and the concept weight are included in the dataset. The dataset may include multiple concepts and multiple concept weights. A concept weight may or may not replace keyword weights of keywords that belong to the group. The concept may include keywords that are synonyms.

The converting module may be referred to as a module for converting a plurality of questions leading to a golden answer, to keywords, concepts and weights.

It is noted that a dataset may include concepts and concept weights and/or keywords and keyword weights.

According to an embodiment of the invention there may be provided a computer implemented method for automatically generating a dataset for a device that recognizes questions posed in a natural language and answers with predefined golden answers; wherein the method may include: analyzing transcripts of natural language interactions between a user and an information provider to recognize and define golden answers; locating occurrences of golden answers within the plurality of transcripts; collecting, from the plurality of transcripts, a plurality of questions leading to a golden answer; and converting a plurality of questions leading to a golden answer, to keywords, concepts and weights.

The transcripts may be logs of a user service chat.

The transcripts may be conversations between users and information providers converted from voice to text.

The transcripts may include answers. The non-transitory computer readable medium may stores instructions that once executed by the computerized system causes the computerized system to count occurrences of same answers within the transcripts; and defining a certain answer from the transcripts to be a golden answer when a number of occurrences of the certain answer within the transcripts passes a pre-determined threshold.

The transcripts may include answers. The non-transitory computer readable medium may store instructions that once executed by the computerized system causes the computerized system to count occurrences of the certain answer within the transcripts by counting occurrences of multiple of words included in the certain answer.

The transcripts may include answers. The non-transitory computer readable medium may store instructions that once executed by the computerized system causes the computerized system to detect an occurrences of the certain answer within the transcripts by performing pairwise comparisons between the certain answer to other answers from the transcripts thereby counting a number of corresponding words that are included in the certain answer and in each one of the other answers.

The non-transitory computer readable medium may store instructions that once executed by the computerized system causes the computerized system to define most common answers in the transcript as golden answers.

The non-transitory computer readable medium may store instructions that once executed by the computerized system causes the computerized system to count occurrences of each golden answer of the golden answers within transcripts that are chat transcripts.

The non-transitory computer readable medium may store instructions that once executed by the computerized system causes the computerized system to determine a number of occurrences of a golden answer by detecting occurrences of plurality of corresponding words from the golden answer.

The non-transitory computer readable medium may store instructions that once executed by the computerized system causes the computerized system to collect, for each golden answer, questions from the user that led to the occurrence of the golden answer.

The non-transitory computer readable medium may store instructions that once executed by the computerized system causes the computerized system to count occurrences of each word in the questions from the user that led to the occurrence of the golden answer and for assigning, to each word in the questions from the user that led to the occurrence of the golden answer, a weight that is responsive to a frequency of occurrences of the word.

The non-transitory computer readable medium may store instructions that once executed by the computerized system causes the computerized system to decrease a weight of each word in response to an occurrence of the word in user questions that are differ from the questions from the user that led to the occurrence of the golden answer.

The non-transitory computer readable medium may store instructions that once executed by the computerized system causes the computerized system to decrease a weight of each word in response to an occurrence of the word in all questions of the user from the transcripts.

The non-transitory computer readable medium may store instructions that once executed by the computerized system causes the computerized system to convert each word in questions from a user to a base form word; count occurrences of each base form word in the questions from the user that led to the occurrence of the golden answer and for assigning, to each base form word in the questions from the user that led to the occurrence of the golden answer, a weight that is responsive to a frequency of occurrences of the base form word.

According to an embodiment of the invention there may be provided a system for automatically generating a dataset for a system that recognizes questions posed in natural language and answers with predefined golden answers. The system may include a module for recognizing and defining golden answers that is configured to analyze a plurality of transcripts of natural language interactions between a user and an information provider to recognize and define golden answers; a module for locating occurrences of golden answers within the plurality of transcripts; a module for collecting, from the plurality of transcripts, a plurality of questions leading to a golden answer; and a module for converting a plurality of questions leading to a golden answer, to keywords, concepts and weights.

According to an embodiment of the invention there may be provided a system. The system may be a computerized system. The system may be configured to automatically generate a dataset for device that recognizes questions posed in natural language and answers with predefined golden answers. The system is configured to analyze a plurality of transcripts of natural language interactions between a user and an information provider. The system may include a module for recognizing and defining golden answers, a module for locating occurrences of golden answers within chat transcripts, a module for collecting a plurality of questions leading to a golden answer, and a module for converting a plurality of questions leading to a golden answer, to keywords, concepts and weights.

The transcripts of natural language interactions between a user and an information provider may be logs of a user service chat.

The transcripts of natural language interactions between a user and an information provider may be conversations between users and information providers converted from voice to text.

The module for recognizing golden answers may include a repository of predefined golden answers.

The module for defining golden answers may include a module that scans a plurality of transcripts of natural language interactions between a user and an information provider and counts the occurrences of the same answer and the answer being considered a golden answer when the number of occurrences of the same answer passes a pre-determined threshold.

The occurrence of the same answer may be determined by an occurrence of a plurality of words contained within an answer.

A determining of a reoccurrence of an answer may be detected by calculating a score that may be generated by comparing pairs of answers and counting the number of corresponding words and two answers may be considered occurrences of the same answer when the score passes a pre-determined threshold.

A word may be considered corresponding when it may be identical in both answers.

Each word may be transformed to base form, and the base form of two words from corresponding answers may be identical.

Each word may be transformed to base form and a thesaurus may be used to determine that two words from corresponding answers may be synonyms.

The number of occurrences of an answer may be counted and the most common answers may be considered golden answers.

The module for locating occurrences of golden answers within the chat transcripts may include a module that scans a plurality chat transcripts, compares golden answer to answers within chat transcripts and counts the occurrences of each golden answer within the chat transcripts.

The occurrence of a golden answer may be determined by an occurrence of a plurality of corresponding words from the golden answer that may be also contained within the answer

The score may be generated by counting the number of words corresponding in both an answer and the golden answer it may be compared to and the answer may be considered an occurrence of a golden answer when the score passes a pre-determined threshold.

The word may be considered corresponding when it may be identical in both the golden answer and the answer.

Each word may be transformed to base form, and the base form of both words from a golden answer and an answer may be identical.

Each word may be transformed to base form and a thesaurus may be used to determine that two words from the golden answer and the answer may be synonyms.

Each answer found to be an occurrence of a golden answer may be logged for further text analysis.

The module for collecting a plurality of questions leading to golden answers may include a module that scans a plurality of chat transcripts with occurrences of golden answers and for each golden answer collects the questions posed by the user prior to the occurrence of the golden answer and logs them.

The question leading to the golden answer may be the last text entered or spoken by the user prior to the information provider responding with the occurrence of a golden answer.

A plurality of questions leading to a golden answer may be analyzed by counting the occurrence of each word in all the questions leading to the golden answer and the weight of each word may be increased by the frequency of number of occurrences of set word.

The weight of each word may be decreased by the frequency of its occurrence in user questions that may be not questions leading to the golden answer.

The weight of each word may be decreased by the frequency of its occurrence in all user questions.

Prior to measuring the frequency of occurrence of each word, all words may be converted to base form, and the weight of each word may be assigned to the base form.

The weight of each base form word may be decreased by the frequency of its occurrence in user questions that may be not questions leading to the golden answer

The weight of each base form word may be decreased by the frequency of its occurrence in all user questions.

Prior to measuring the frequency of occurrence of each base form word, the thesaurus may be used to convert a plurality of base form words to a common concept and the weight may be assigned to the concept.

The weight of each base form word may be decreased by the frequency of its occurrence in user questions that may be not questions leading to the golden answer. The weight of each base form word may be decreased by the frequency of its occurrence in all user questions.

The system may include a module for determining a quality of an answer.

The quality of an answer may be determined by a user feedback indicating the answer may be relevant.

The user feedback may be provided by answering a user satisfaction question.

The quality of the answer may be indicated by analyzing the next text from the user.

The analysis may be designed to indicate the occurrence of positive words.

The positive words may be one or more words from the group of: great, thanks, good, excellent or any other words indicating the answer provided was of high value.

The multiple possible answers may be presented to the user and the user selects a relevant answer and the answer selected may be automatically considered to be of high quality.

Each answer may receive a score indicating the level of satisfaction and only answers with a score over a predetermined threshold may be considered of high quality.

The only answers which may be deemed to be of high quality may be used as a basis for golden answer occurrence search.

The score of each answer may be retained and the score may be used to modify the weights provided to keywords and concepts.

According to an embodiment of the invention there may be provided a system for defining golden answers from a plurality of transcripts of natural language interactions between a user and an information provider that may include a module that scans a plurality of transcripts of natural language interactions between a user and an information provider and counts the occurrences of the same answer and the answer being considered a golden answer when the number of occurrences of the same answer passes a pre-determined threshold.

The occurrence of the same answer may be determined by an occurrence of a plurality of words contained within an answer.

Multiple occurrences of a same answer may be detected by calculating a score that may be generated by comparing pairs of answers and counting the number of corresponding words and two answers may be considered occurrences of the same answer when the score passes a pre-determined threshold.

The word may be considered corresponding when it may be identical in both answers.

Each word may be transformed to base form, and the base form of two words from corresponding answers may be identical.

Each word may be transformed to base form and a thesaurus may be used to determine that two words from corresponding answers may be synonyms

The number of occurrences of an answer may be counted and the most common answers may be considered golden answers.

According to an embodiment of the invention there may be provided a system for locating occurrences of golden answers from a plurality of transcripts of natural language interactions between a user and an information provider wherein the system may include a module that scans a plurality chat transcripts, compares golden answer to answers within chat transcripts and counts the occurrences of each golden answer within the chat transcripts.

An occurrence of a golden answer may be determined by an occurrence of a plurality of corresponding words from the golden answer that may be also contained within the answer.

The score may be generated by counting the number of words corresponding in both an answer and the golden answer it may be compared to and the answer may be considered an occurrence of a golden answer when the score passes a pre-determined threshold.

The word may be considered corresponding when it may be identical in both the golden answer and the answer.

Each word may be transformed to base form, and the base form of both words from a golden answer and an answer may be identical.

Each word may be transformed to base form and a thesaurus may be used to determine that two words from the golden answer and the answer may be synonyms.

Each answer found to be an occurrence of a golden answer may be logged for further text analysis.

According to an embodiment of the invention there may be provided a system for collecting a plurality of questions leading to a golden answers from a plurality of transcripts of natural language interactions between a user and an information provider may include a module that scans a plurality of chat transcripts with occurrences of golden answers and for each golden answer collects the questions posed by the user prior to the occurrence of the golden answer and logs them.

The question leading to the golden answer may be the last text entered or spoken by the user prior to the information provider responding with the occurrence of a golden answer.

According to an embodiment of the invention there may be provided a system for converting questions leading to the golden answers from a plurality of transcripts of natural language interactions between a user and an information provider to keywords, concepts and weights wherein a plurality of questions leading to a golden answer may be analyzed by counting the occurrence of each word in all the questions leading to the golden answer and the weight of each word may be increased by the frequency of number of occurrences of set word.

The weight of each word may be decreased by the frequency of its occurrence in user questions that may be not questions leading to the golden answer.

The weight of each word may be decreased by the frequency of its occurrence in all user questions.

Prior to measuring the frequency of occurrence of each word, all words may be converted to base form, and the weight of each word may be assigned to the base form.

The weight of each base form word may be decreased by the frequency of its occurrence in user questions that may be not questions leading to the golden answer.

The weight of each base form word may be decreased by the frequency of its occurrence in all user questions.

Prior to measuring the frequency of occurrence of each base form word, the thesaurus may be used to convert a plurality of base form words to a common concept and the weight may be assigned to the concept.

The weight of each base form word may be decreased by the frequency of its occurrence in user questions that may be not questions leading to the golden answer.

The weight of each base form word may be decreased by the frequency of its occurrence in all user questions.

According to an embodiment of the invention there may be provided a system to determine the quality of an answer in a plurality of transcripts of natural language interactions between a user and an information provider.

The quality of an answer may be determined by a user feedback indicating the answer may be relevant.

The user feedback may be provided by answering a user satisfaction question.

The quality of the answer may be indicated by analyzing the next text from the user.

The analysis may be designed to indicate the occurrence of positive words.

The positive words may be one or more words from the group of: great, thanks, good, excellent or any other words indicating the answer provided was of high value.

The multiple possible answers may be presented to the user and the user selects a relevant answer and the answer selected may be automatically considered to be of high quality.

Each answer receives a score indicating the level of satisfaction and only answers with a score over a predetermined threshold may be considered of high quality.

The only answers which may be deemed to be of high quality may be used as a basis for golden answer occurrence search.

The score of each answer may be retained and the score may be used to modify the weights provided to keywords and concepts.

According to an embodiment of the invention there may be provided a system for determining the quality of an answer in a chat transcript between a user and an information provider where the quality of the answer may be indicated by analyzing the next text from the user.

The analysis may be designed to indicate the occurrence of positive words.

The positive words may be one or more words from the group of: great, thanks, good, excellent or any other words indicating the answer provided was of high value.

The multiple possible answers may be presented to the user and the user selects a relevant answer and the answer selected may be automatically considered to be of high quality.

Each answer receives a score indicating the level of satisfaction and only answers with a score over a predetermined threshold may be considered of high quality.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 illustrates a chat according to an embodiment of the invention;

FIG. 2 illustrates a system for automatically generating a dataset for a system that recognizes questions posed in natural language and answers with predefined golden answers according to an embodiment of the invention;

FIG. 3 illustrates a system for automatically generating a dataset for a system that recognizes questions posed in natural language and answers with predefined golden answers with a module to determine the quality of an answer according to an embodiment of the invention;

FIG. 4 illustrates data flow for a module for recognizing and defining golden answers according to an embodiment of the invention;

FIG. 5 illustrates two sample chats with identical occurrences of the same golden answer according to an embodiment of the invention;

FIG. 6 illustrates two sample chats with occurrences of the same golden answer that are not identical according to an embodiment of the invention;

FIG. 7 illustrates data flow for a module for locating occurrences of golden answers within chat transcripts according to an embodiment of the invention;

FIG. 8 illustrates data flow for a module for collecting a plurality of questions leading to a golden answer according to an embodiment of the invention;

FIG. 9 illustrates data flow for a module for converting a plurality of questions leading to a golden answer, to keywords, concepts and weights according to an embodiment of the invention;

FIG. 10 illustrates a plurality of questions leading to a golden answer according to an embodiment of the invention;

FIG. 11 illustrates a thesaurus according to an embodiment of the invention;

FIG. 12 illustrates a golden answer and corresponding question concepts according to an embodiment of the invention;

FIG. 13 illustrates a golden answer and corresponding question weighted concepts according to an embodiment of the invention;

FIG. 14 illustrates a system according to an embodiment of the invention;

FIG. 15 illustrates a system according to an embodiment of the invention; and

FIG. 16 illustrates a system according to an embodiment of the invention.

### DETAILED DESCRIPTION OF THE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

There are provided a system and a method for automatically generating a dataset for a system that recognizes questions posed in natural language and answers with predefined answers. More particularly, the present invention pertains to a system and method for recognizing commonly used answers, such as those posed in customer service and the patterns of words used in questions to which these answers provide relevant response. The system or method may feed into an automated user interaction system such as customer service chat.

An automated user interaction system based on natural language receives statements or queries from a user, such as a customer entering a customer service site, and attempts to comprehend the query and provide the most appropriate response.

Automated customer support systems are known in prior art such as the system detailed in U.S. Pat. No. 8,548,915 B2 or U.S. Pat. No. 7,603,413 B1. Typically, these systems use a pre-defined dataset which includes answers crafted in advance to provide the most effective solution to most commonly asked questions and problems. Often, these answers are also used by human customer support agents and are sometimes referred to as “golden answers”. In addition to these golden answers, automated answering system often contains a set of rules or guidelines designed to help match the optimal golden answer to a customer's query.

Often, these rules are based on matching a set of keywords to each answer. A query is analyzed to detect the presence of each keyword. A score is derived by multiplying each keyword by a weight (score) which is designed to indicate how indicative each keyword is of a given answer being relevant. A mathematical computation such as adding the weights of all present keywords is derived for each golden answer. By comparing the score to a predetermined threshold, the system can decide whether the golden answer is relevant. If more than one golden answer is found to be relevant, multiple answers can be displayed. Alternatively, the system may display one or more answers with the highest scores.

In some cases, creating the dataset for the automated response system requires extensive manual work to define golden answers and analyze the optimal configuration of keywords and weights for each golden answer. This invention describes a system or method to automate the entire process of creating the dataset, or to create an initial dataset which can then be manually optimized, saving considerable time and effort.

The term “module” may include a hardware module such as a processor, a hardware accelerator, a controller, a computer, a server, or instructions, software, firmware, code, application or microcode executed by a hardware module. The instructions, software, firmware, code, application or microcode may be stored in a non-transitory computer readable medium. The module may receive transcripts of any kind of network.

The term “golden answer” refers hereinafter to a combination of words, spoken, written or otherwise communicated to a user in response to a query or request. The golden answer may be an answer designed to answer a common question and approved by a customer service organization to be technically accurate and in line with the organization's policy on customer service. The golden answer may be used in other systems other than the automated response system, such as the guidelines for human customer support agents. The golden answer may appear with minor variations.

The term “user” refers hereinafter to a human or system simulating a human that contacts a support or information providing using natural language queries or requests. The user may be a customer contacting a customer support site on the internet, through text or by voice.

The term “information provider” refers hereinafter to an entity providing information to a user. The information provider may be a human or computer system. The information provider may be a customer support agent interacting with a customer via chat or by voice over the phone or internet.

The term “concept” refers hereinafter to a group of keywords that have similar meanings. This may be a group of synonyms in a thesaurus. Terms in the thesaurus can be predefined based on the words in the relevant scenario or from an external dictionary

According to an embodiment of the invention golden answers may be detected by the following: agents usually use a repository of answers from which they copy and paste during their conversations with users. They sometime change several words, but mostly they either don't change the answer or add a connecting sentence before or after it.

Similar golden answers may be detected by trying to compare pairs of text to each other instead of comparing all documents to all other documents. When agents are indeed using repository of answers, the method can create an index of these answers, as well to keywords in them, and this index can be used to find these answers in the chat-logs. (i.e. If a transcript answer contains keywords A, B, C). The computer can easily check in the index it created which answers in the repository contain all or part of these keywords, and after a small list of possible matches have been found, an algorithm for comparing strings can be used to determine if they are indeed similar or just share a few words. Algorithms for comparing strings are known in the art as Longest common sub-sequence Algorithms, and are used in document comparison tools.

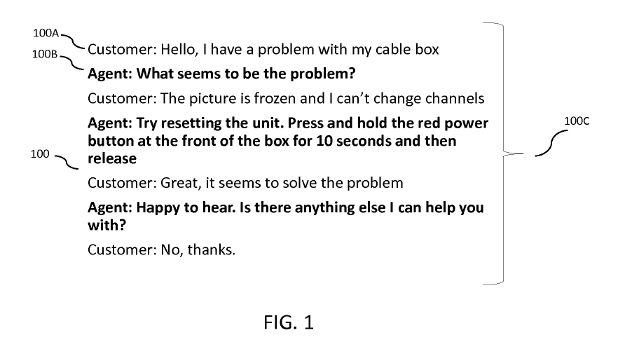

Using a computer implemented method or a computerized system to execute the computer implemented method facilitates highly accurate results as the method can go over vast amounts of chat logs—millions of chat logs can be proceeded in minutes, rather than months/years by a human. Given the real time nature of chats this computerized analysis solves a problem that cannot be solved by humans. Reference is no made to FIG. 1, which is a Sample Chat. FIG. 1 includes a chat transcript (100C) describing a conversation between a user (100A) and an information provider (100B). In one embodiment the user is a customer and the information provider is a customer service agent. In one embodiment the conversation is carried out by online chat through a website. In another embodiment the conversation is a transcript of a phone conversation.

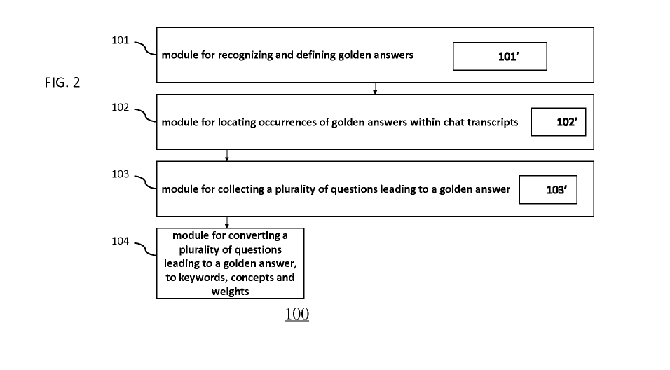

Reference is now made to FIG. 2, which is a schematic flow diagram a system 100 for automatically generating a dataset for a system that recognizes questions posed in natural language and answers with predefined golden answers. The system is comprised of a module for recognizing and defining golden answers (101), a module for locating occurrences of golden answers within chat transcripts (102), a module for collecting a plurality of questions leading to a golden answer (103) and a module for converting a plurality of questions leading to a golden answer, to keywords, concepts and weights (104). The system receives a plurality of chat transcripts. In one embodiment the system further receives a plurality of pre-defined golden answers. In another embodiment the system outputs a plurality of golden answers.

The module (101) for defining golden answers may include a module (101′) that scans a plurality of transcripts of natural language interactions between a user and an information provider and counts the occurrences of the same answer and the answer being considered a golden answer when the number of occurrences of the same answer passes a pre-determined threshold.

The module (102) for locating occurrences of golden answers within the chat transcripts may include a module (102′) that scans a plurality chat transcripts, compares golden answer to answers within chat transcripts and counts the occurrences of each golden answer within the chat transcripts.

The module (103) for collecting a plurality of questions leading to golden answers may include a module (103′) that scans a plurality of chat transcripts with occurrences of golden answers and for each golden answer collects the questions posed by the user prior to the occurrence of the golden answer and logs them.

Additionally, the system outputs a dataset which can be used in an automated system for interaction between a user and an information provider. In one embodiment the system outputs keywords which are used to recognize questions and allow automatic selection of the appropriate golden answer. In another embodiment the system outputs concepts which are used to recognize questions and allow automatic selection of the appropriate golden answer. In yet another embodiment the system outputs a combination of concepts and keywords which are used to recognize questions and allow automatic selection of the appropriate golden answer. In yet another embodiment, the system outputs weights corresponding to keywords that assist in better correlating keywords or concepts in a question to the optimal golden answer.

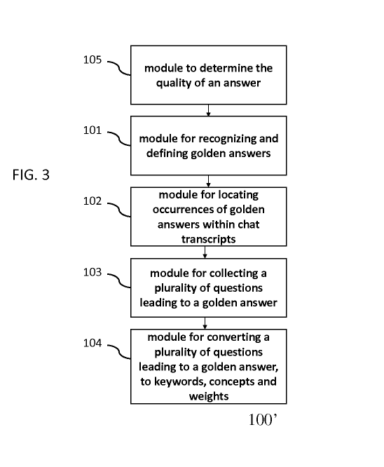

Reference is made to FIG. 3 which describes a system 100′ for automatically generating a dataset for a system that recognizes questions posed in natural language and answers with predefined golden answers with a module to determine the quality of an answer. The system comprises a module to determine the quality of an answer (105) in which operates prior to the module for recognizing and defining golden answers (101), the module for locating occurrences of golden answers within chat transcripts (102), the module for collecting a plurality of questions leading to a golden answer (103) and the module for converting a plurality of questions leading to a golden answer, to keywords, concepts and weights (104). In one embodiment, the module to determine the quality of an answer is used to eliminate answers which were deemed unsuccessful prior to operating the other modules. In one embodiment, this is done to improve accuracy of definition of golden answers, keywords, concepts and weights.

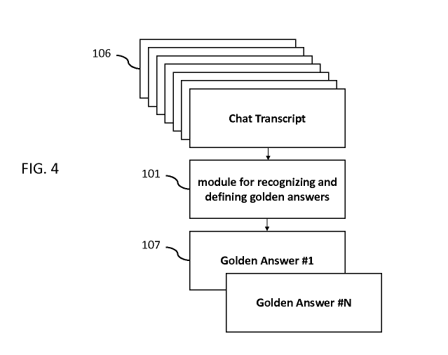

Reference is made to FIG. 4 which describes one embodiment of data flow for a module for recognizing and defining golden answers. A module for recognizing and defining golden answers (101) receives chat transcripts (106) and outputs a plurality of golden answers (107). The module for recognizing and defining golden answers (101) analyzes the chat transcripts (106) for similar answers and groups them. Each group of answers is counted and the group is considered a golden answer when the number of occurrences of the same answer passes a pre-determined threshold. In one embodiment, an answer considered similar by an occurrence of a plurality of words contained within an answer. In one embodiment a score that is generated by comparing pairs of answers and counting the number of corresponding words and two answers are considered occurrences of the same answer when the score passes a pre-determined threshold. In one embodiment a word is considered corresponding when it is identical in both answers. In another embodiment each word is transformed to base form, and the base form of two words from corresponding answers are identical. In one embodiment converting a word to base form is done by removing all bias from the word for example converting all words from plural to single, from past and future to present tense etc. In one embodiment this is done by industry standard software tools. In one embodiment the words are further compared using a thesaurus and two words are considered the same if they are synonyms. In one embodiment the thesaurus may be customized for each industry or customer. In one embodiment, golden answers may be derived from a pre-existing dataset of golden answers. In one embodiment this dataset may be manually inputted to the system. In another embodiment, this dataset may be automatically inputted from a knowledge management system.

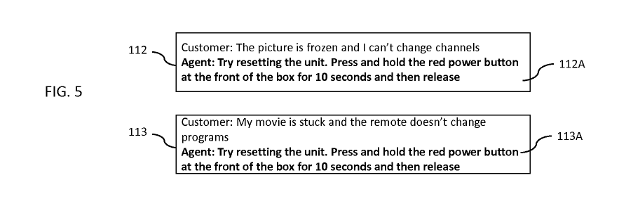

Reference is made to FIG. 5 which describes one example of two sample chats with identical occurrences of the same golden answer. A sample of from a first chat (112) is compared to a sample of a second chat (113) by the module for recognizing and defining golden answers (101). The answer provided in the first chat (112A) is found identical to the answer provided in the second chat (113A). Both answers are then grouped together. If the enough identical answers are found, the group will be considered a golden answer.

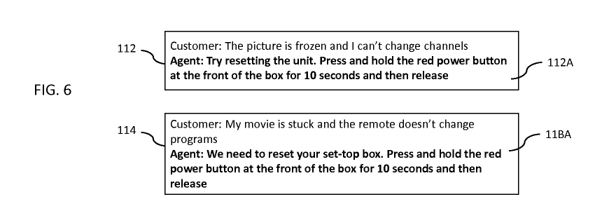

Reference is made to FIG. 6 which describes one example of two sample chats with occurrences of the same golden answer that are not identical. A sample of from a first chat (112) is compared to a sample of a third chat (114) by the module for recognizing and defining golden answers (101). The answer provided in the first chat (112A) is not identical to the answer provided in the third chat (114A), have enough identical words to be considered similar and therefore in the same group. In yet a different example, some of the words are variations of other words in other answers and when converted to base form and compared by a thesaurus are found to be similar and the answers are then considered similar.

Reference is made to FIG. 6 which describes one embodiment of a data flow for a module for locating occurrences of golden answers within chat transcripts. A plurality of chat transcripts (106) and a dataset of golden answers (107) are inputted to the module for locating occurrences of golden answers within chat transcripts (102). The module analyzes the chat transcripts, locates occurrences of golden answers and marks them to produce a plurality of chat transcripts with marked occurrences of golden answers (108). In one embodiment marking the occurrences of the golden answers can be done by creating an additional document which includes location data. In one embodiment this document is an XML document and the tags include chat ID and a pointer to the exact line.

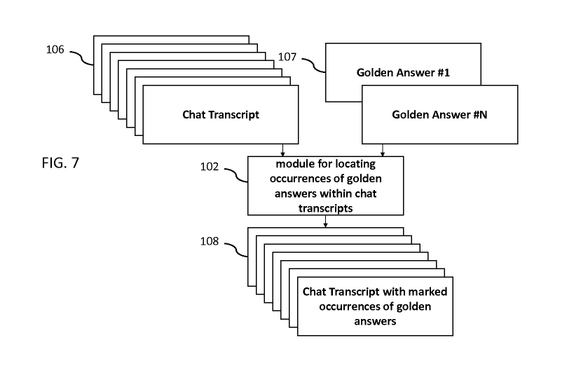

Further reference is made to FIG. 7. In one embodiment an occurrence of a golden answer is determined by an occurrence of a plurality of corresponding words from the golden answer that is also contained within the answer. In one embodiment a score is generated by counting the number of words corresponding in both an answer and the golden answer it is compared to and the answer is considered an occurrence of a golden answer when the score passes a pre-determined threshold. In one embodiment, a word is considered corresponding when it is identical in both the golden answer and the answer. In another embodiment each word is transformed to base form, and the base form of both words from a golden answer and an answer are identical. In another embodiment after transforming each word to base form, a thesaurus is used to determine that two words from the golden answer and the answer are synonyms. In one embodiment the thesaurus is customized for each industry or company.

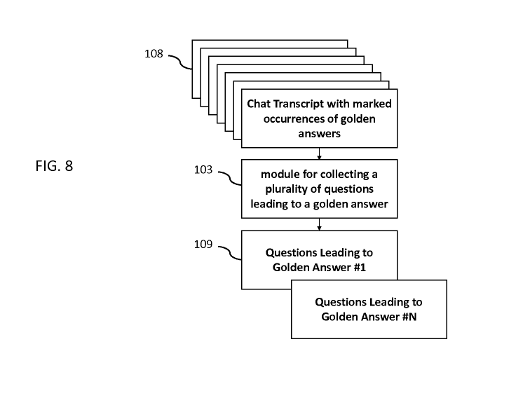

Reference is made to FIG. 8 which describes one embodiment of a data flow for a module for collecting a plurality of questions leading to a golden answer. A plurality of chat transcripts with marked occurrences of golden answers (108) is inputted to the module for collecting a plurality of questions leading to a golden answer (103). The module analyzes the transcripts with marked occurrences of golden answers and outputs a plurality of questions leading to golden answers (108). In one embodiment each question is tagged with the ID of the golden answer is relates to. In one embodiment these questions are stored in a separate document. In one embodiment this document is an XML document and the tags include sample question, golden answer ID. In one embodiment analyzing the chat transcripts with marked occurrences of golden answers is done by extracting the question immediately prior to the occurrence of the golden answer.

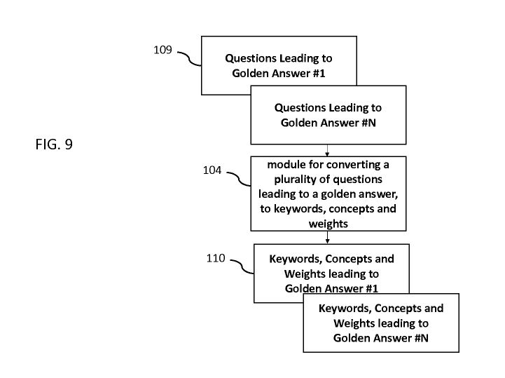

Reference is made to FIG. 9 which describes one embodiment of a data flow for a module for converting a plurality of questions leading to a golden answer, to keywords, concepts and weights. A plurality of questions leading to golden answers (109) is inputted to the module for converting a plurality of questions leading to a golden answer, to keywords, concepts and weights (104). The module analyzes the questions leading to golden answers (109) and for each golden answer outputs Keywords, Concepts and Weights leading to the golden answer (110) all combined into a dataset. In one embodiment analyzing the questions leading to the golden answers (109) is done by counting the occurrence of each word in each of the questions, and the most common words being used in the dataset. In one embodiment weights are assigned to each keyword and are used to indicate the relative likelihood of each keyword in a question to predict the likelihood of a given golden answer following it. In one embodiment the weight of each word is decreased by the frequency of its occurrence in user questions that are not questions leading to the golden answer. In one embodiment the weight of each word is decreased by the frequency of its occurrence in all user questions. In one embodiment, prior to measuring the frequency of occurrence of each word, all words are converted to base form, and the weight of each word is assigned to the base form. In one embodiment, after being converted to base form, a thesaurus is used to convert a plurality of base form words to a common concept and the weight is assigned to the concept rather than to the keyword.

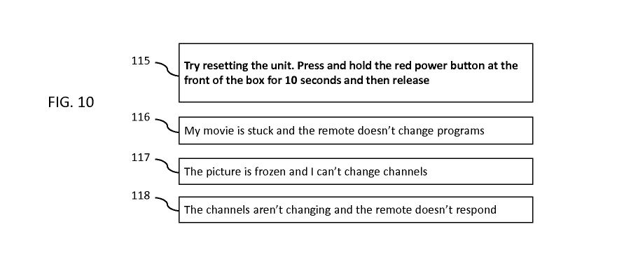

Reference is made to FIG. 10 which describes an example of plurality of questions leading to a golden answer. A golden answer (115) is linked to a first question leading to a golden answer (116), a second question leading to a golden answer (117) and a third question leading to a golden answer (118). In this example each question is different but represents a similar problem encountered by a customer of a cable operator. In this example, the answers were all derived from transcripts of chat between cable company customers and a human support agent.

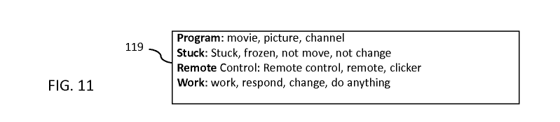

Reference is made to FIG. 11 which describes an example of a thesaurus. A thesaurus (119) contains keywords in base for example movie, picture and channel which are all related to the same concept entitled picture. In one example the thesaurus is an industry specific thesaurus and although picture and channel are not synonyms in other thesauruses, they are deemed synonyms in this thesaurus as they are commonly used interchangeably.

It should be noted that the software should have access to a list of stop words (similar to what search engines use, this list depends on the language the content is written in), these words are frequent language words, that should not be given same importance as real content word (keywords) when analyzing the golden questions and/or when analyzing the golden answers.

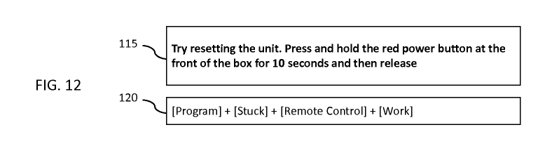

Reference is made to FIG. 12 which describes an example of a golden answer and corresponding concepts. A dataset containing concepts (120) is linked to a golden question (115). In one example the concepts are: “program”, “stuck”, “remote control” and “work”. In one example if a user enters a query which includes all these words or synonyms of these words as defined by a thesaurus a response will be generated with the golden answer (115). In another example, a query could contain only part of the concepts to trigger the golden answer (115).

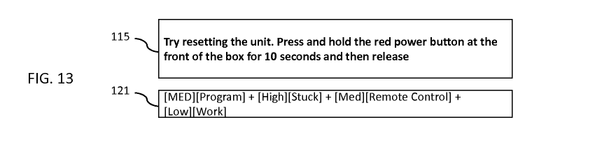

Reference is made to FIG. 13 which describes an example of a golden answer and corresponding concepts and weights. A dataset containing concepts and weights (121) is linked to a golden question (115). In one example the concepts are: “program”, “stuck”, “remote control” and “work” and the corresponding weights are Medium, High, Medium and Low. In one example if a user enters a query which includes the word “stuck” or any synonym of stuck as well as any of the other words a system will provide the golden answer (115). In one example, if a user enters a query which includes the word “work” or its synonym and the word “program” or any of its synonyms, but not the word stuck or any of its synonyms, the system will not provide the golden answer (115).

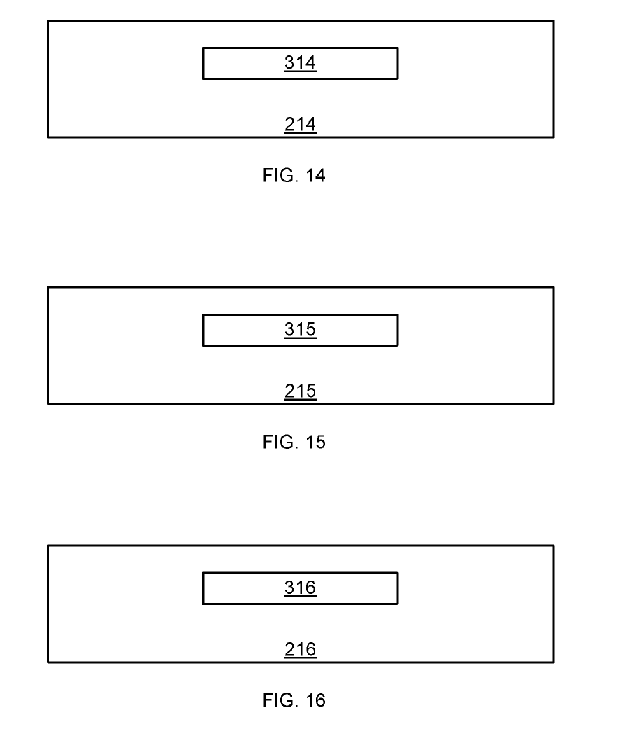

FIG. 14 illustrates system 214 for defining golden answers from a plurality of transcripts of natural language interactions between a user and an information provider that may include a module 314 that scans a plurality of transcripts of natural language interactions between a user and an information provider and counts the occurrences of the same answer and the answer being considered a golden answer when the number of occurrences of the same answer passes a pre-determined threshold.

FIG. 15 illustrates system 215 for locating occurrences of golden answers from a plurality of transcripts of natural language interactions between a user and an information provider wherein the system may include a module 315 that scans a plurality chat transcripts, compares golden answer to answers within chat transcripts and counts the occurrences of each golden answer within the chat transcripts.

FIG. 16 illustrates system 216 for collecting a plurality of questions leading to a golden answers from a plurality of transcripts of natural language interactions between a user and an information provider may include a module 216′ that scans a plurality of chat transcripts with occurrences of golden answers and for each golden answer collects the questions posed by the user prior to the occurrence of the golden answer and logs them.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for automatically generating a dataset for a device that recognizes questions posed in a natural language and answers with predefined golden answers; wherein the system comprises: a module for recognizing and defining golden answers that is configured to analyze transcripts of natural language interactions between a user and an information provider to recognize and define golden answers; a module for locating occurrences of golden answers within the plurality of transcripts; a module for collecting, from the plurality of transcripts, a plurality of questions leading to a golden answer; and a converting module for converting a plurality of questions leading to a golden answer to at least one keyword to at least one keyword weight; wherein multiple golden answers, multiple keywords associated with the multiple golden answers and multiple keyword weights form a dataset; wherein an incoming question is evaluated as being a question that is responded by a golden answer using the dataset.

2. The system according to claim 1 wherein at least one golden answer is associated with a concept that comprises a group of keywords of similar meaning; wherein the converting module assigns a concept weight; wherein the concept and the concept weight are included in the dataset.

3. A computer implemented method for automatically generating a dataset for a device that recognizes questions posed in a natural language and answers with predefined golden answers; wherein the method comprises: analyzing transcripts of natural language interactions between a user and an information provider to recognize and define golden answers; locating occurrences of golden answers within the plurality of transcripts; collecting, from the plurality of transcripts, a plurality of questions leading to a golden answer; and converting a plurality of questions leading to a golden answer to at least one keyword to at least one keyword weight; wherein multiple golden answers, multiple keywords associated with the multiple golden answers and multiple keyword weights form a dataset; wherein an incoming question is evaluated as being a question that is responded by a golden answer using the dataset.

4. The method according to claim 3 wherein at least one golden answer is associated with a concept that comprises a group of keywords of similar meaning; wherein the method further comprises assigning a concept weight; wherein the concept and the concept weight are included in the dataset.

5. A non-transitory computer readable medium that stores instructions that once executed by a computerized system causes the computerized system to execute the steps of: analyzing transcripts of natural language interactions between a user and an information provider to recognize and define golden answers; wherein the transcripts comprise answers; locating occurrences of golden answers within the plurality of transcripts; collecting, from the plurality of transcripts, a plurality of questions leading to a golden answer; and converting a plurality of questions leading to a golden answer to at least one keyword to at least one keyword weight; wherein multiple golden answers, multiple keywords associated with the multiple golden answers and multiple keyword weights form a dataset; wherein an incoming question is evaluated as being a question that is responded by a golden answer using the dataset.

6. The non-transitory computer readable medium according to claim 3, wherein at least one golden answer is associated with a concept that comprises a group of keywords of similar meaning; wherein the non-transitory computer readable medium further stores instructions that once executed by the computerized system causes the computerized system to assign a concept weight; wherein the concept and the concept weight are included in the dataset.

7. The non-transitory computer readable medium according to claim 5, wherein the transcripts are logs of a user service chat.

8. The non-transitory computer readable medium according to claim 5, wherein the transcripts are conversations between users and information providers converted from voice to text.

9. The non-transitory computer readable medium according to claim 5, wherein the non-transitory computer readable medium further stores instructions that once executed by the computerized system causes the computerized system to count occurrences of same answers within the transcripts; and defining a certain answer from the transcripts to be a golden answer when a number of occurrences of the certain answer within the transcripts passes a pre-determined threshold.

10. The non-transitory computer readable medium according to claim 5, wherein the non-transitory computer readable medium further stores instructions that once executed by the computerized system causes the computerized system to count occurrences of the certain answer within the transcripts by counting occurrences of multiple of words included in the certain answer.

11. The non-transitory computer readable medium according to claim 5, wherein the non-transitory computer readable medium further stores instructions that once executed by the computerized system causes the computerized system to detect an occurrences of the certain answer within the transcripts by performing pairwise comparisons between the certain answer to other answers from the transcripts thereby counting a number of corresponding words that are included in the certain answer and in each one of the other answers.

12. The non-transitory computer readable medium according to claim 5, wherein the non-transitory computer readable medium further stores instructions that once executed by the computerized system causes the computerized system to define most common answers in the transcript as golden answers.

13. The non-transitory computer readable medium according to claim 5, wherein the non-transitory computer readable medium further stores instructions that once executed by the computerized system causes the computerized system to count occurrences of each golden answer of the golden answers within transcripts that are chat transcripts.

14. The non-transitory computer readable medium according to claim 5, wherein the non-transitory computer readable medium further stores instructions that once executed by the computerized system causes the computerized system to determine a number of occurrences of a golden answer by detecting occurrences of plurality of corresponding words from the golden answer.

15. The non-transitory computer readable medium according to claim 5, wherein the non-transitory computer readable medium further stores instructions that once executed by the computerized system causes the computerized system to collect, for each golden answer, questions from the user that led to the occurrence of the golden answer.

16. The non-transitory computer readable medium according to claim 5, wherein the non-transitory computer readable medium further stores instructions that once executed by the computerized system causes the computerized system to count occurrences of each word in the questions from the user that led to the occurrence of the golden answer and for assigning, to each word in the questions from the user that led to the occurrence of the golden answer, a weight that is responsive to a frequency of occurrences of the word.

17. The non-transitory computer readable medium according to claim 16, wherein the non-transitory computer readable medium further stores instructions that once executed by the computerized system causes the computerized system to decrease a weight of each word in response to an occurrence of the word in user questions that are differ from the questions from the user that led to the occurrence of the golden answer.

18. The non-transitory computer readable medium according to claim 16, wherein the non-transitory computer readable medium further stores instructions that once executed by the computerized system causes the computerized system to decrease a weight of each word in response to an occurrence of the word in all questions of the user from the transcripts.

19. The non-transitory computer readable medium according to claim 5, wherein the non-transitory computer readable medium further stores instructions that once executed by the computerized system causes the computerized system to convert each word in questions from a user to a base form word; count occurrences of each base form word in the questions from the user that led to the occurrence of the golden answer and for assigning, to each base form word in the questions from the user that led to the occurrence of the golden answer, a weight that is responsive to a frequency of occurrences of the base form word.

20. The non-transitory computer readable medium according to claim 19, wherein the non-transitory computer readable medium further stores instructions that once executed by the computerized system causes the computerized system to decrease a weight of each base form word in response to an occurrence of the base form word in user questions that are differ from the questions from the user that led to the occurrence of the golden answer.

21. The non-transitory computer readable medium according to claim 19, wherein the non-transitory computer readable medium further stores instructions that once executed by the computerized system causes the computerized system to decrease a weight of each base form word in response to an occurrence of the base form word in all questions of the user from the transcripts.

22. The non-transitory computer readable medium according to claim 5, wherein the non-transitory computer readable medium further stores instructions that once executed by the computerized system causes the computerized system to evaluate a quality of an answer in response to a user feedback, found within the transcripts, indicating that the answer is relevant.
